(19) United States
(12) Patent Application Publication
(10) Pub. No.: US 2025/0300306 A1
(43) Pub. Date: Sep. 25, 2025

(54) BATTERY CASE

(71) Applicant: Isuzu Motors Limited, Yokohama-shi (JP)

(72) Inventors: Kazuhiro TATEISHI, Fujisawa-shi (JP); Akihiro NAGAFUCHI, Fujisawa-shi (JP); Wataru OKADA, Fujisawa-shi (JP)

(73) Assignee: Isuzu Motors Limited, Yokohama-shi (JP)

(21) Appl. No.: 19/056,953

(22) Filed: Feb. 19, 2025

(30) Foreign Application Priority Data
Mar. 22, 2024 (JP) 2024-046673

(51) Int. Cl. H01M 50/291; H01M 10/643; H01M 50/213; H01M 50/503; H01M 50/505; H01M 50/516

(52) U.S. Cl. CPC H01M 50/291; H01M 10/643; H01M 50/213; H01M 50/503; H01M 50/505; H01M 50/516

(57) ABSTRACT

A battery case includes: a first frame in which a plurality of first housing holes each capable of housing one end portion of a battery cell are formed, the battery cell having connection terminals at the one end portion; and a second frame in which a plurality of second housing holes each capable of housing the other end portion of the battery cell are formed, the second frame forming a housing chamber, using the first housing hole and the second housing hole, the housing chamber being capable of housing the battery cell, in which the second housing hole includes a positioning portion for positioning the other end portion of the battery cell in a housing direction, and the positioning portion is a protrusion portion formed to protrude toward an inside of the second housing hole over an entire circumference of a lower end portion of the second housing hole.

### CROSS REFERENCE TO RELATED APPLICATIONS

This application claims the benefit of priority of Japanese Patent Application No. 2024-046673 filed on Mar. 22, 2024. The contents of the above application is all incorporated by reference as if fully set forth herein in its entirety.

### TECHNICAL FIELD

The present disclosure relates to a battery case.

### BACKGROUND ART

A battery module that houses a large number of battery cells in a battery case and connects a conductive member to the connection terminals of the battery cells has been known. The Patent Literature (hereinafter referred to as “PTL”) discloses a cooling structure in which a heat conductive material is brought into contact with a battery cell and a cooling plate to release heat for cooling.

### CITATION LIST

### Patent Literature

### PTL

Japanese Unexamined Patent Application Publication (Translation of PCT Application) No. 2023-524698

### SUMMARY OF INVENTION

### Technical Problem

In a case where a plurality of battery cells are housed in a battery case, there may be variation in the positions of the plurality of battery cells in a height direction. At this time, the thermal conductivity between the bottom surfaces of the battery cells and the cooling plate varies, which may reduce the cooling quality for some battery cells.

An object of the present disclosure is to provide a battery case capable of suppressing variation in position of a battery cell in a height direction and suppressing a reduction in the cooling quality of a bottom surface of the battery cell.

### Solution to Problem

A battery case of the present disclosure includes: a first frame in which a plurality of first housing holes each capable of housing one end portion of a battery cell are formed, the battery cell having connection terminals at the one end portion; and a second frame in which a plurality of second housing holes each capable of housing the other end portion of the battery cell are formed, the second frame forming a housing chamber, using the first housing hole and the second housing hole, the housing chamber being capable of housing the battery cell, in which the second housing hole includes a positioning portion for positioning the other end portion of the battery cell in a housing direction, and the positioning portion is a protrusion portion formed to protrude toward an inside of the second housing hole over an entire circumference of a lower end portion of the second housing hole.

### Advantageous Effects of Invention

In the present disclosure, a lower end portion of each battery cell in a second housing hole of a second frame is fixed in order to align the height of a bottom surface of the battery cell with respect to a battery case, thereby suppressing a reduction in the cooling quality of the bottom surface of the battery cell.

### BRIEF DESCRIPTION OF DRAWINGS

FIG. 1 illustrates an appearance of a battery module;

FIG. 2 is an exploded view of the battery module;

FIG. 3 is a further exploded view of the battery module;

FIG. 4 is a partial cutaway perspective cross-sectional view of a second frame;

FIG. 5A is an enlarged view of the second frame;

FIG. 5B is another enlarged view of the second frame;

FIG. 6A is an enlarged view of a first variation of the second frame;

FIG. 6B is another enlarged view of the first variation of the second frame;

FIG. 7A is an enlarged view of a second variation of the second frame;

FIG. 7B is another enlarged view of the second variation of the second frame;

FIG. 8A is an enlarged view of a third variation of the second frame;

FIG. 8B is another enlarged view of the third variation of the second frame;

FIG. 9A is an enlarged view of a fourth variation of the second frame;

FIG. 9B is another enlarged view of the fourth variation of the second frame;

FIG. 10 is an exploded view of a conventional battery module;

FIG. 11A illustrates an appearance of the conventional battery module; and

FIG. 11B is a partial enlarged view of the conventional battery module.

### DESCRIPTION OF EMBODIMENTS

Hereinafter, an embodiment of the present disclosure will be described with reference to the accompanying drawings. The embodiment described below indicates a specific example of the present disclosure. Therefore, each component, the arrangement position and the connection form of each component, and the like illustrated in the following embodiment are examples and are not intended to limit the present disclosure. In addition, components that are not described in the independent claims among components in the following embodiment are described as optional components.

Each drawing is a schematic diagram and is not necessarily a strict illustration. In each drawing, the substantially same configuration are given the same reference numerals, and redundant explanations are omitted or simplified.

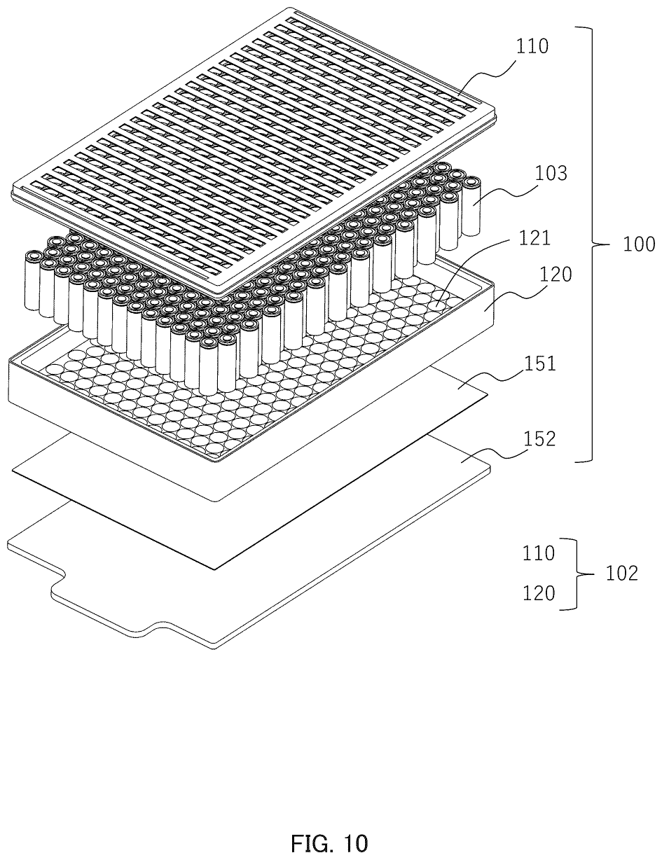

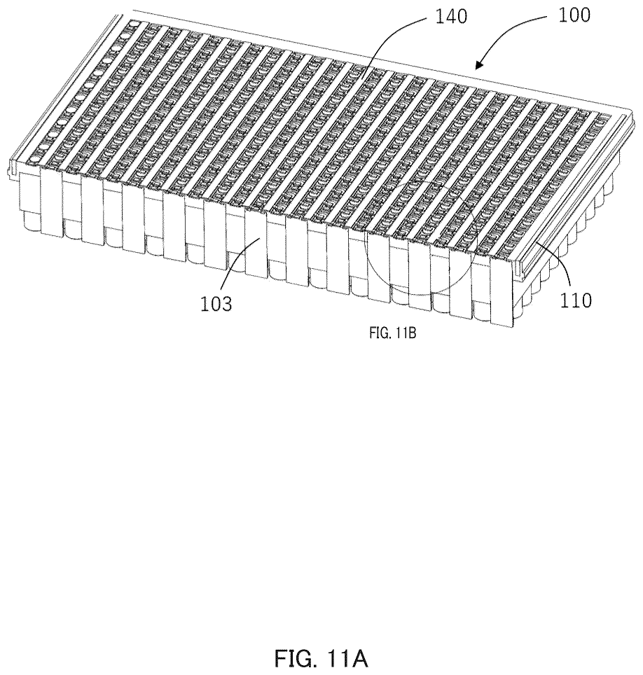

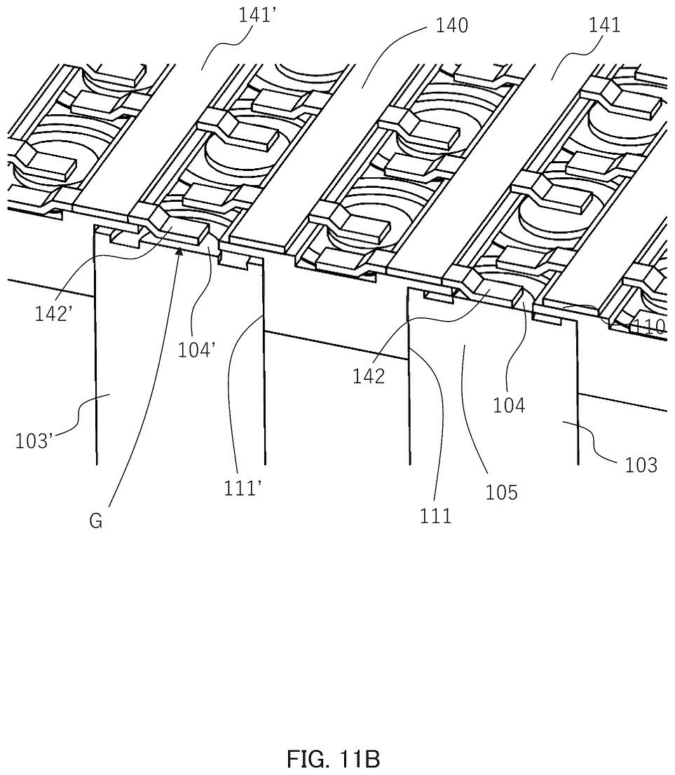

First, battery module 100 of a comparative example will be described. A battery module that houses a large number of battery cells in a battery case and connects a conductive member to the connection terminals of the battery cells has been known. FIG. 10 is an exploded view of a main part of conventional battery module 100. FIG. 11A illustrates an appearance of battery module 100, and FIG. 11B is a partial enlarged view thereof. Note that some members are omitted from the drawings.

Battery cell 103 is housed in battery case 102 including first frame 110 and second frame 120. First frame 110 and second frame 120 are each formed with a large number of first housing holes 111 and second housing holes 121 facing correspondingly each other, and a housing chamber for battery cell 103 is formed by first housing hole 111 and second housing hole 121.

Upper portion 105 of battery cell 103 is housed in first housing hole 111, and a lower portion of battery cell 103 is housed in second housing hole 121, thereby fixing and housing battery cell 103 in battery case 102.

Bus bar 140 as a conductive member is provided on an upper surface of first frame 110, and connection piece 142 formed to protrude laterally from main body portion 141 is overlaid on connection terminals 104 of battery cell 103 and is bonded by laser welding or the like. Note that, in the illustrated example, bus bar 140 and connection terminals 104 are bonded by connection piece 142, but main body portion 141 of bus bar 140 and connection terminals 104 may be connected by wire bonding.

For assembling battery module 100, second frame 120 is mounted on a mounting table such that second housing hole 121 is oriented upward, battery cell 103 is housed in second housing hole 121 such that connection terminals 104 faces upward, and thus, first frame 110 is placed on and coupled to second frame 120 such that first housing hole 111 faces downward and upper portion 105 of battery cell 103 is housed in first housing hole 111.

Next, bus bar 140 is attached onto first frame 110, and connection piece 142 is bonded to connection terminals 104. Then, a potting agent (not illustrated) is applied in order to coat bus bar 140, over which a top cover (not illustrated) is placed. Further, cooling plate 152 is bonded to a bottom portion of second frame 120 with adhesive 151.

Since bus bar 140 is formed from a plate-shaped member by press molding or the like, the heights of the large number of connection pieces 142 are substantially the same. When connection pieces 142 are bonded to connection terminals 104, a gap may be formed between some connection pieces 142 and connection terminals 104 unless the heights of connection terminals 104 of the plurality of battery cells 103 are not aligned.

In FIG. 11B, battery cell 103 located on a right side has an appropriate height and is inserted to the deepest part (the uppermost part in the drawing) of first housing hole 111, so that connection piece 142 and connection terminals 104 are in appropriate contact with each other, whereas battery cell 103′ located on a left side is at a lower position than battery cell 103 on the right side, and thus is not inserted to the deepest part of first housing hole 111′; hence, gap G is formed between connection piece 142′ and connection terminals 104′.

In order to bond connection piece 142′ and connection terminals 104′ to each other, the processing becomes complicated, such as bonding while lifting battery cell 103′ or bonding while pressing down connection piece 142′, resulting in a decrease in the efficiency in the bonding operation. Additionally, even when the bonding is successful, there is a problem in that the bonding quality is reduced due to an internal stress remaining in connection piece 142′.

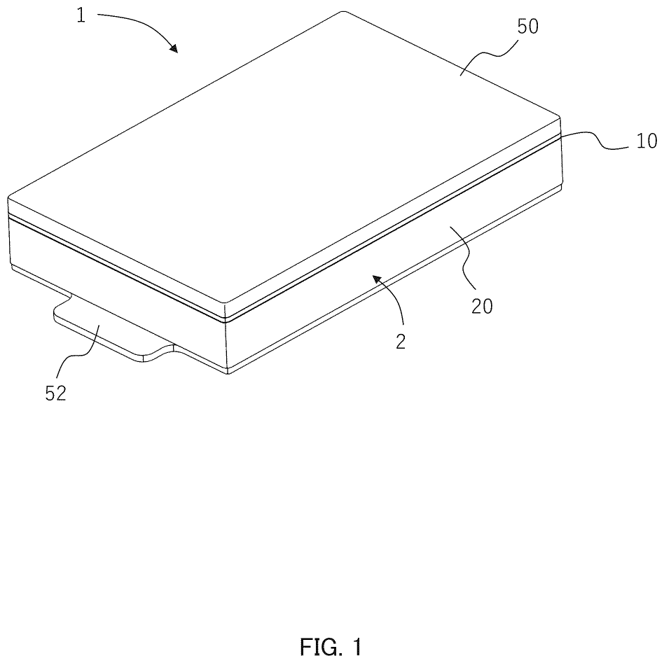

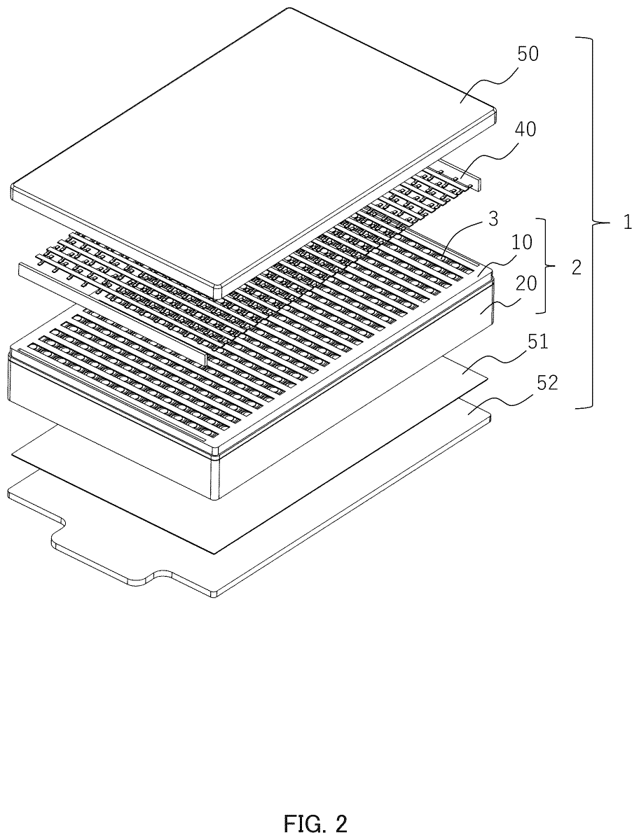

FIG. 1 illustrates an appearance of battery module 1 of the present disclosure, and FIG. 2 is an exploded view of battery module 1. Battery module 1 houses a large number of battery cells 3 in battery case 2 made of resin. Battery case 2 includes first frame 10 and second frame 20, and first frame 10 and second frame 20 form therein housing chambers for battery cells 3. Bus bar 40 is attached onto an upper surface of first frame 10 and is connected to connection terminals of battery cells 3. Bus bar 40 is coated with a potting agent (not illustrated), and further, top cover 50 is provided thereon to cover upper surfaces of first frame 10 and bus bar 40. Further, cooling plate 52 is bonded to a lower surface of second frame 20 with adhesive 51. Lower surfaces of battery cells 3 are exposed from a lower portion of second frame 20 and are connected to cooling plate 52 via adhesive 51.

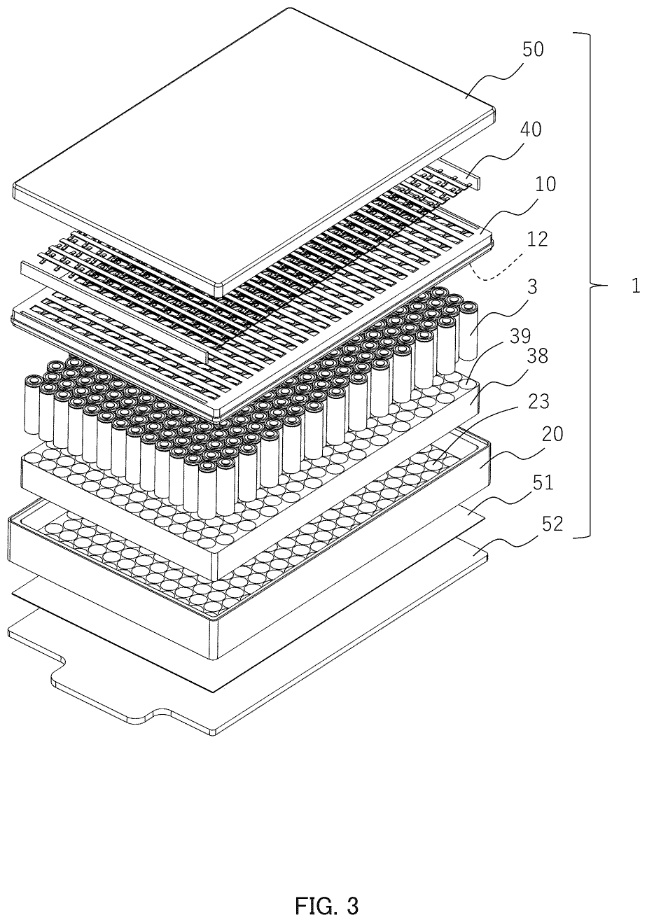

FIG. 3 is a further exploded view of battery case 2 of battery module 1. Second frame 20 is a container-shaped member with an open top, in which a large number of second housing holes 23 for housing the lower portions of battery cells 3 are formed. Second frame 20 houses therein heat insulating material 38 in which a large number of through-holes 39 into which battery cells 3 are inserted are formed. Battery cells 3 are inserted into through-holes 39 such that the lower portions thereof are housed in second housing holes 23 and intermediate portions thereof are surrounded by heat insulating material 38.

First housing holes 12 that house the upper portions of battery cells 3 are formed in first frame 10 and are assembled to second frame 20 to configure battery case 2. Battery cells 3 are housed in first housing holes 12, through-holes 39, and second housing holes 23.

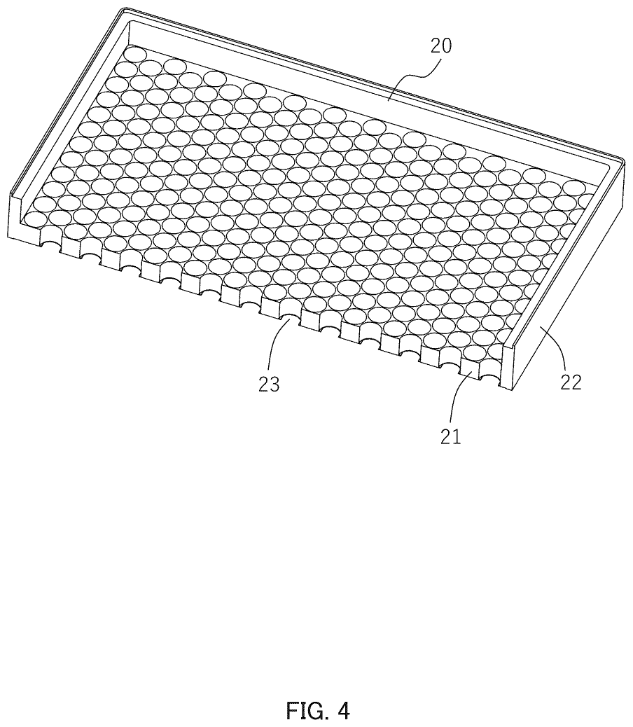

FIG. 4 is a partial cutaway perspective cross-sectional view of second frame 20. Second frame 20 includes main body portion 21, which is a plate-shaped, and side wall portion 22 that rises around main body portion 21. A large number of second housing holes 23, in which the lower portion of battery cells 3 are housed, are formed to penetrate main body portion 21 vertically.

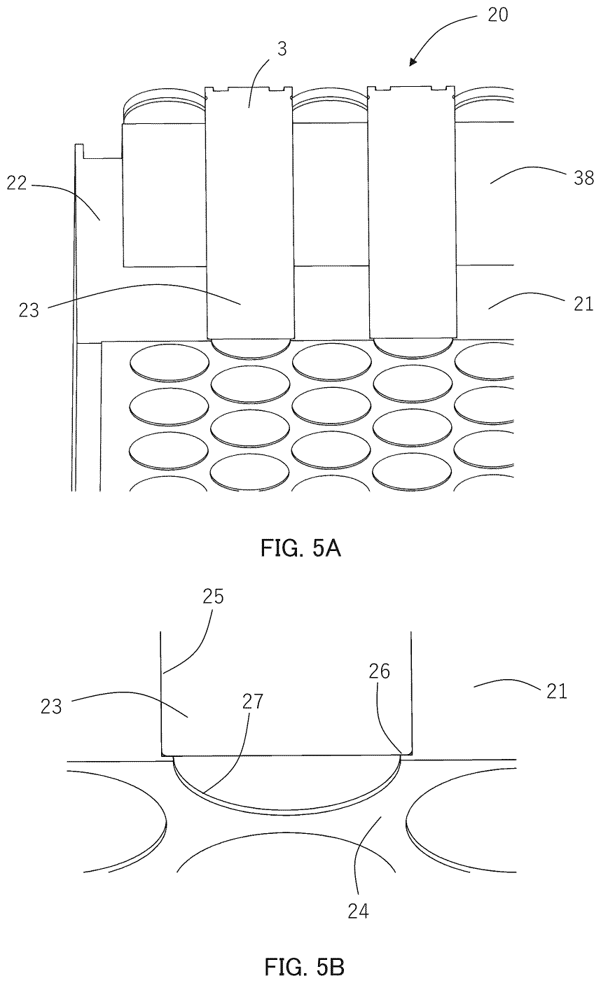

FIGS. 5A and 5B are each an enlarged partial cutaway perspective cross-sectional view of a state in which heat insulating material 38 and battery cell 3 are assembled to second frame 20, as viewed from obliquely downward. Protrusion portion 26 that protrudes inward is formed on a lower end portion of inner wall 25 of second housing hole 23. Protrusion portion 26 (annular flange portion) is formed to protrude with substantially the same width over the entire circumference of inner wall 25 having a substantially circular cross-section. That is, inner circumferential edge 27 of protrusion portion 26 has a substantially circular shape. Further, a lower surface of protrusion portion 26 is the same plane as lower surface 24 of main body portion 21.

The lower portion of each battery cell 3 is inserted into second housing hole 23 from above, and a lower end surface of battery cell 3 is in contact with protrusion portion 26, thereby supporting and positioning battery cell 3 within second housing hole 23. Thus, the heights of bottom surfaces of battery cells 3 housed in battery case 2 are aligned, making it possible to prevent a reduction in the cooling quality of the battery cells when a cooling plate is bonded to a lower surface of battery case 2. Further, since the positions of connection terminals 4 of battery cells 3 in an up-down direction are all aligned, it becomes easier to bond connection pieces 42 of bus bar 40 and connection terminals 4, thereby improving the quality of a connection portion.

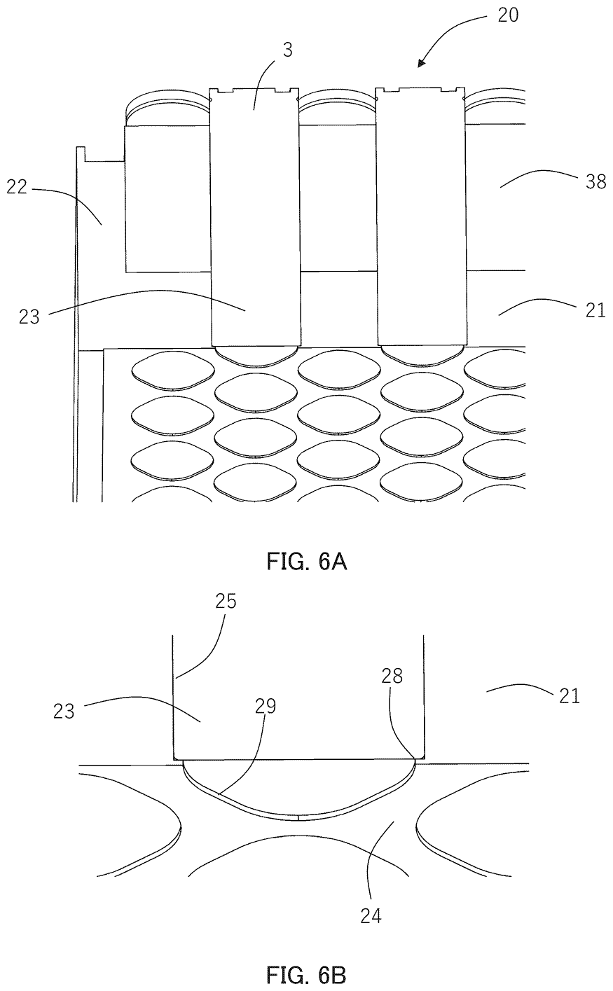

FIGS. 6A and 6B are each illustrate a first variation of second frame 20. Protrusion portion 28 that protrudes inward is formed on the lower end portion of inner wall 25 of second housing hole 23. Protrusion portion 28 (annular flange portion) is formed to protrude over the entire circumference of inner wall 25 having a substantially circular cross-section, but the width of the protrusion portion is not constant. In this example, inner circumferential edge 29 of protrusion portion 28 has a substantially quadrangular shape. Adopting such a shape makes it possible to improve the manufacturing efficiency and reduce the amount of material used while the function of positioning the bottom portions of battery cells 3 is maintained.

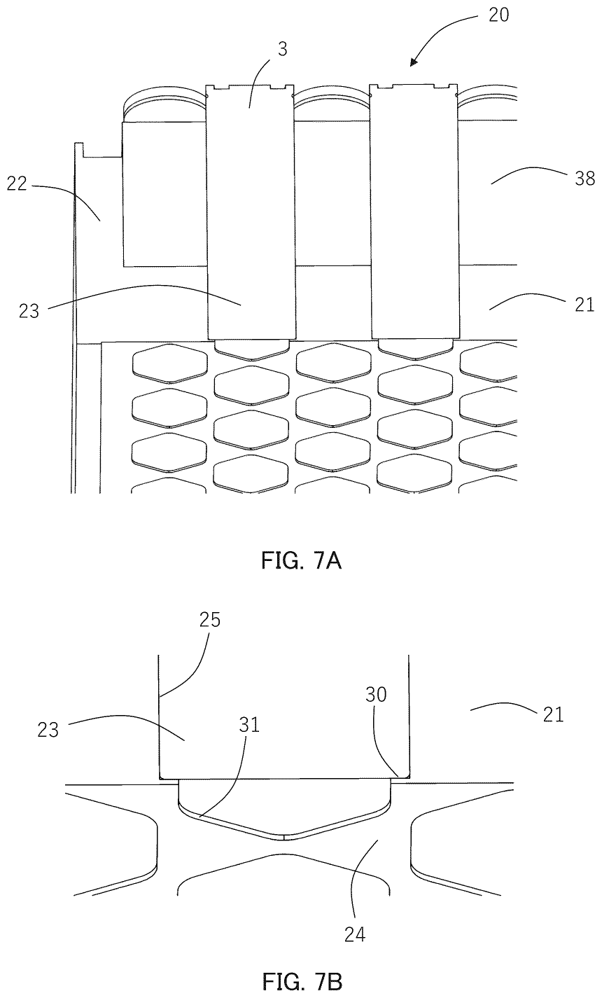

FIGS. 7A and 7B are each illustrate a second variation of second frame 20. Protrusion portion 30 that protrudes inward is formed on the lower end portion of inner wall 25 of second housing hole 23. Protrusion portion 30 (annular flange portion) is formed to protrude over the entire circumference of inner wall 25 having a substantially circular cross-section, but the width of the protrusion portion is not constant. In this example, inner circumferential edge 31 of protrusion portion 30 has a substantially hexagonal shape. Adopting such a shape makes it possible to improve the manufacturing efficiency and reduce the amount of material used while the function of positioning the bottom portions of battery cells 3 is maintained.

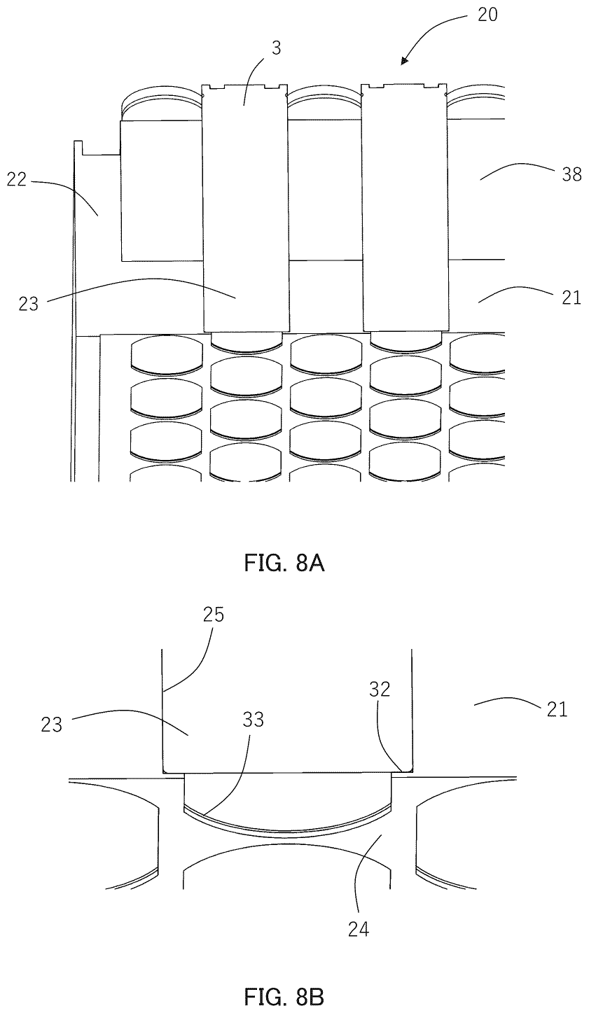

FIGS. 8A and 8B are each illustrate a third variation of second frame 20. Protrusion portion 32 that protrudes inward is formed on the lower end portion of inner wall 25 of second housing hole 23. Protrusion portion 32 is formed to protrude at two points facing each other on inner wall 25 having a substantially circular cross-section, and there is portion 33 in which protrusion portion 32 is not formed (a plurality of flange portions). Adopting such a shape makes it possible to improve the manufacturing efficiency and reduce the amount of material used while the function of positioning the bottom portions of battery cells 3 is maintained.

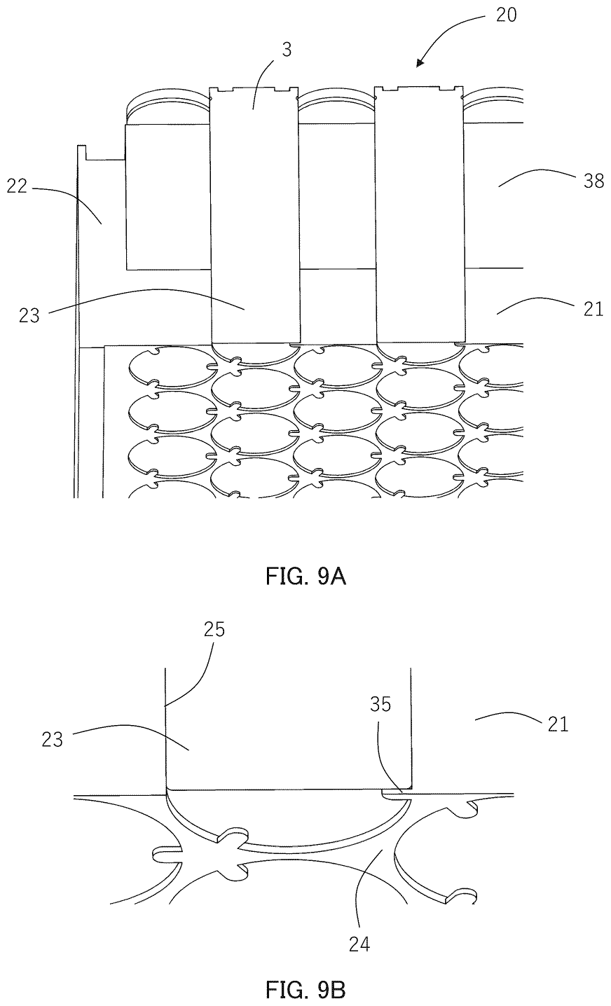

FIGS. 9A and 9B are each illustrate a fourth variation of second frame 20. Protrusion portion 35 that is claw-shaped and protrudes inward is formed on the lower end portion of inner wall 25 of second housing hole 23. In this example, three protrusion portions 35 are formed to be equidistant from each other with respect to one second housing hole 23, and to be close to protrusion portions 35 of other adjacent second housing holes 23. Further, in this example, unlike the fourth variation, lower surfaces of protrusion portions 35 are on the same plane as lower surface 24 of main body portion 21. Adopting such a shape makes it possible to improve the manufacturing efficiency and reduce the amount of material used while the function of positioning the bottom portions of battery cells 3 is maintained.

In the above examples, the protrusion portion is provided on the lower end portion of the second housing hole as a positioning portion, but the form of the positioning portion is not limited to the above examples. Further, the above examples can be appropriately modified or combined.

### INDUSTRIAL APPLICABILITY

The present disclosure can be suitably used for a battery module.

### REFERENCE SIGNS LIST

1 Battery module
2 Battery case
3 Battery cell
10 First frame
20 Second frame
40 Bus bar
50 Top cover

1. A battery case, comprising:
a first frame in which a plurality of first housing holes each capable of housing one end portion of a battery cell are formed, the battery cell having connection terminals at the one end portion; and
a second frame in which a plurality of second housing holes each capable of housing the other end portion of the battery cell are formed, the second frame forming a housing chamber, using the first housing hole and the second housing hole, the housing chamber being capable of housing the battery cell, wherein:
the second housing hole includes a positioning portion for positioning the other end portion of the battery cell in a housing direction, and
the positioning portion is a protrusion portion formed to protrude toward an inside of the second housing hole over an entire circumference of a lower end portion of the second housing hole.

2. The battery case according to claim 1, wherein the protrusion portion is an annular flange portion with an inner circumferential edge having a substantially circular shape.

3. The battery case according to claim 1, wherein the protrusion portion is an annular flange portion with an inner circumferential edge having a substantially quadrangular shape.

4. The battery case according to claim 1, wherein the protrusion portion is an annular flange portion with an inner circumferential edge having a substantially hexagonal shape.

5. A battery case, comprising:
a first frame in which a plurality of first housing holes each capable of housing one end portion of a battery cell are formed, the battery cell having connection terminals at the one end portion; and
a second frame in which a plurality of second housing holes each capable of housing the other end portion of the battery cell are formed, the second frame forming a housing chamber, using the first housing hole and the second housing hole, the housing chamber being capable of housing the battery cell, wherein:
the second housing hole includes a positioning portion for positioning the other end portion of the battery cell in a housing direction,
the positioning section is a protrusion portion provided on at least a part of a lower end portion of the second housing hole and formed to protrude toward an inside of the second housing hole, and
a lower surface of the protrusion portion is flush with a lower surface of the second frame.

6. The battery case according to claim 5, wherein the protrusion portion is a plurality of flange portions formed to face each other.

7. The battery case according to claim 5, wherein the protrusion portion is a plurality of claw portions.

8. A battery module, comprising:
the battery case according to claim 1;
a plurality of battery cells, one end portion of each of which is housed in the first housing hole, and the other end portion of each of the plurality of battery cells is housed in the second housing hole and is positioned and fixed by the positioning portion, the one end portion including connection terminals; and
a conductive member that is attached to an outer surface of the first frame and is connected to the connection terminals of each of the plurality of battery cells.

9. The battery module according to claim 8, wherein:
the conductive member is a plate-shaped bus bar; and
the bus bar and the connection terminals are connected to each other by laser welding.
